(19) United States
(12) Patent Application Publication
(10) Pub. No.: US 2025/0236079 A1
(43) Pub. Date: Jul. 24, 2025

(54) Thermoplastic fiber composite film manufacturing mechanism and manufacturing method thereof

(71) Applicant: YI SHEN PLASTIC CORP., Changhua County (TW)

(72) Inventors: Chun-Hsien Wu, Changhua County (TW); Chun-Ye Wu, Changhua County (TW)

(21) Appl. No.: 18/420,821

(22) Filed: Jan. 24, 2024

(51) Int. Cl. B29D 7/01; B29C 48/00; B29C 48/08; B32B 5/02; B32B 27/12

(52) U.S. Cl. CPC B29D 7/01; B29C 48/0018; B29C 48/0021; B29C 48/08; B32B 5/024; B32B 27/12

(57) ABSTRACT

A thermoplastic fiber composite film manufacturing mechanism and method are provided. The mechanism includes a substrate outputting module, a fiber material outputting module, and a pressing module. The substrate outputting module continuously outputs a film-shaped molten plastic substrate along an output direction. The fiber material outputting module is disposed on one side of the substrate outputting module. The fiber material outputting module continuously outputs a fiber sheet material. The pressing module is disposed on one side of the fiber material outputting module away from the substrate outputting module. The pressing module has a first and a second rollers neighboring each other, with a pressing area formed therebetween. The plastic substrate and the fiber sheet material move to the pressing area; the first and second rollers press the plastic substrate and the fiber sheet material together in parallel into a composite film.

### BACKGROUND OF THE INVENTION

### 1. Field of the Invention

The present invention relates to manufacturing mechanism and manufacturing methods, and more particularly, to a thermoplastic fiber composite film manufacturing mechanism and manufacturing method thereof.

### 2. Description of the Related Art

Conventional products on the market, such as sports equipment, vehicles, and electronic products, are usually manufactured with materials such as carbon fiber, plastic fiber, or glass fiber. Carbon fiber materials have higher strength but are fragile and not resistant to crushing and pressing. Plastic fiber materials, on the other hand, have lower strength but are resistant to crushing and pressing. Therefore, manufacturers combine carbon fiber and plastic fiber materials to create composite materials having high strength and light weight.

Usually, two methods are used for manufacturing the aforementioned composite materials. The first method is mixing carbon fiber powder with plastic particles to carry out the injection molding operation. Regarding the composite materials accordingly produced, the carbon fibers are not linked; in other words, the material does not have a long fiber structure. As a result, the aforementioned composite materials still have structural strength insufficiency issue. The second method is soaking the carbon fiber material sheet in molten plastic, so that the plastic is attached to the surface of the carbon fiber materials. Because the thickness of the plastic layer attached to the surface of the carbon fiber materials is difficult to be under precise control, the composite materials accordingly produced have an issue of low uniformity. Also, the aforementioned methods have the disadvantages of lower manufacturing efficiency and higher cost.

### SUMMARY OF THE INVENTION

The present invention aims at resolving the issue of insufficient strength and low uniformity of conventional carbon fiber composite materials.

For achieving the aforementioned objectives, a thermoplastic fiber composite film manufacturing mechanism in accordance with an embodiment of the present invention comprises a substrate outputting module, a fiber material outputting module, and a pressing module. The substrate outputting module continuously outputs a plastic substrate formed in a film shape and in a molten status along an output direction. The fiber material outputting module is disposed on one side of the substrate outputting module, and comprises a rolled up fiber sheet material. The fiber material outputting module is configured to continuously output the fiber sheet material. The pressing module is disposed on one side of the fiber material outputting module away from the substrate outputting module. The pressing module comprises a first roller and a second roller disposed neighboring each other, with a pressing area formed therebetween. The pressing module receives the plastic substrate and the fiber sheet material. The plastic substrate and the fiber sheet material move to the pressing area, such that the first roller and the second roller press the plastic substrate and the fiber sheet material together in parallel into a composite film.

Also, the present invention provides a thermoplastic fiber composite film manufacturing method, comprising: a substrate outputting step: using a substrate outputting module to output a plastic substrate formed in a film shape and in a molten status along an output direction; a pressing step: using a pressing module to receive the plastic substrate and a fiber sheet material of a fiber material outputting module, and press the plastic substrate and the fiber sheet material together in parallel into a composite film.

With such configuration, the width of the pressing area of the present invention is fixed, so as to fix the thickness of the composite film, achieving a unified thickness of the composite film. Also, with the first roller and the second roller having relatively low temperature, the present invention efficiently lowers the temperature of the composite film, such that the plastic substrate and the fiber sheet material are stably combined, enhancing the structural strength of the composite film. Besides, the composite film of the present invention is manufactured through a one-step process, achieving the advantages of higher manufacturing speed and lower production cost.

### BRIEF DESCRIPTION OF THE DRAWINGS

FIG. 1 is a perspective view of the thermoplastic fiber composite film manufacturing mechanism in accordance with an embodiment of the present invention.

FIG. 2 is a front view of the operation status of the thermoplastic fiber composite film manufacturing mechanism in accordance with an embodiment of the present invention.

FIG. 3 is a partially enlarged view of the thermoplastic fiber composite film manufacturing mechanism in accordance with an embodiment of the present invention.

FIG. 4 is a flow chart of the thermoplastic fiber composite film manufacturing method in accordance with an embodiment of the present invention.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

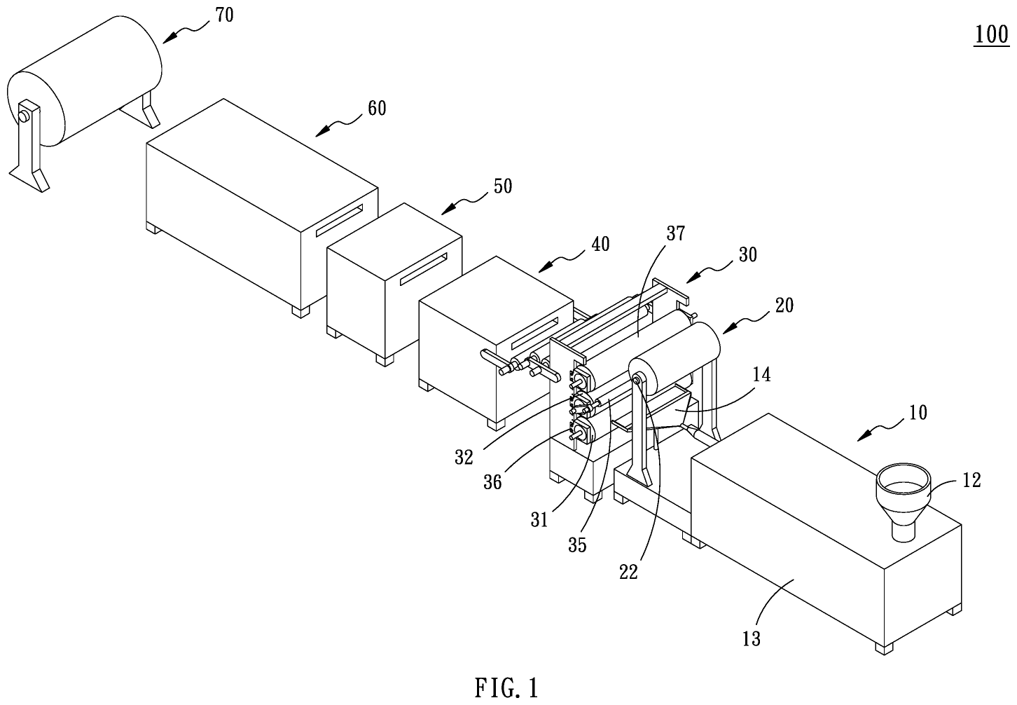

Referring to FIG. 1 to FIG. 3, the present invention provides a thermoplastic fiber composite film manufacturing mechanism 100, comprising a substrate outputting module 10, a fiber material outputting module 20, and a pressing module 30. Therein, the present invention further comprises a trimming module 40, a cleaning module 50, a stretching module 60, and a rolling module 70. The trimming module 40, the cleaning module 50, the stretching module 60, and the rolling module 70 are orderly disposed toward a direction of the pressing module 30 away from the substrate outputting module 10.

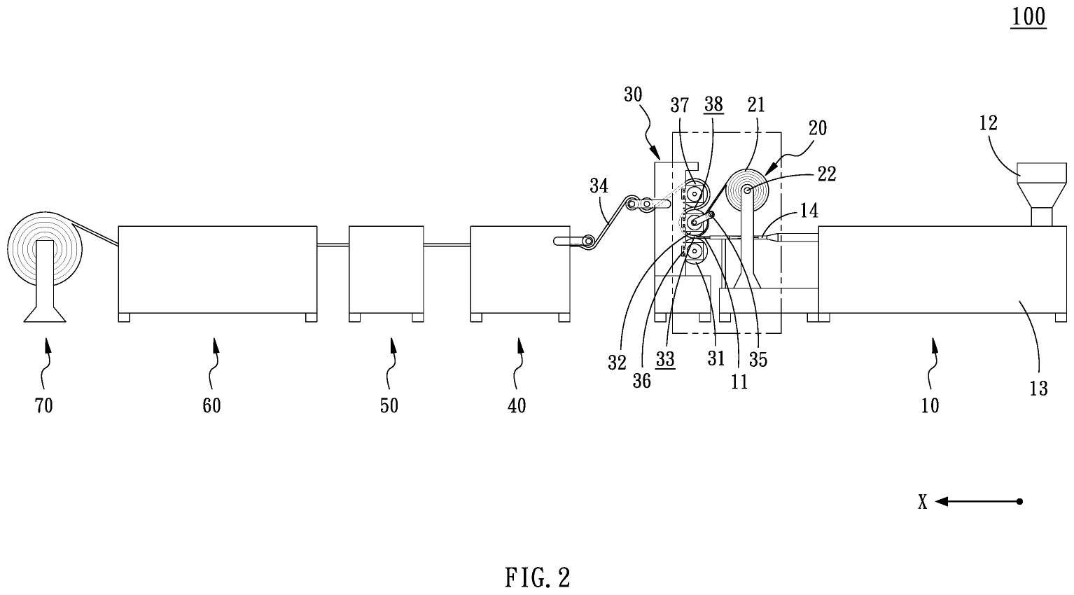

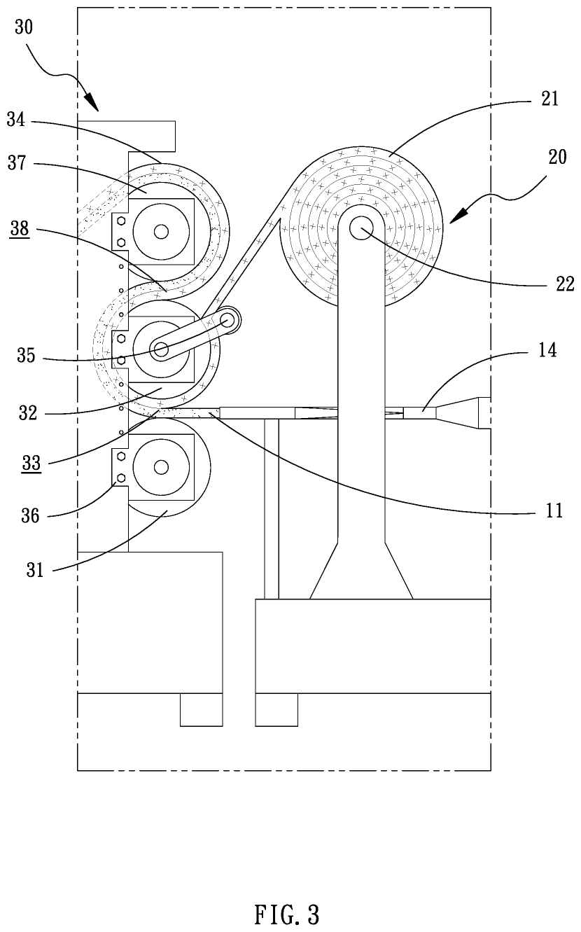

The substrate outputting module 10 continuously outputs a plastic substrate 11 formed in a film shape and in a molten status along an output direction X. As shown by FIG. 2 and FIG. 3, in the embodiment, the substrate outputting module 10 comprises an inputting part 12, a heating part 13, and an outputting part 14 orderly disposed along the output direction X. The inputting part 12 is configured to input a plastic raw material (not shown), and the plastic raw material is allowed to be a thermoplastic raw material, such as PVC or Nylon material. The heating part 13 is configured to heat the plastic raw material, so that the plastic raw material is melted into a plastic substrate 11 presented in a glue form, so as to be outputted through the outputting part 14. Therein, the heating part 13 is allowed to be a thermal conductive threaded rod. The outputting part 14 expands along the output direction X and is formed in a flat shape, so that the outputting part 14 outputs the plastic substrate 11 in a sheet shape and unifies the thickness of the plastic substrate 11, thereby preventing the inconsistent thickness of the plastic substrate 11.

Also, in another embodiment of the present invention, the outputting part 14 comprises an adjustment member (not shown), by which the user adjusts the height of an outlet of the outputting part 14 to adjust the thickness of the plastic substrate 11 according to actual demands.

The fiber material outputting module 20 is disposed on one side of the substrate outputting module 10 and has a rolled-up fiber sheet material 21. The fiber material outputting module 20 continuously outputs the fiber sheet material 21 to the pressing module 30. In the embodiment, the fiber sheet material 21 is a fiber thread woven into a sheet shape, so that the resistance of the fiber sheet material 21 is improved. Therein, the fiber sheet material 21 is allowed to be made of a material selected from unidirectional carbon fiber, bidirectional carbon fiber, glass fiber mat, glass fiber yarn bundle, Kevlar fiber, mineral fiber, and plant fiber.

Referring to FIG. 1 to FIG. 3, in the embodiment, the fiber material outputting module 20 further comprises a resistance mechanism 22, which passes through the fiber sheet material 21 along an axial direction of the rolled fiber sheet material 21, thereby increasing the resistance of the fiber sheet material 21 being pulled, whereby the fiber sheet material 21 is in a tense status before entering the pressing module 30, facilitating the subsequent pressing operation.

The pressing module 30 is disposed on one side of the fiber material outputting module 20 away from the outputting module 10. The pressing module 30 comprises a first roller 31, a second roller 32, and a pressing area 33. The second roller 32 neighbors the first roller 31, with the pressing area 33 formed between the first roller 31 and the second roller 32. The pressing module 30 receives the plastic substrate 11 and the fiber sheet material 21. The plastic substrate 11 and the fiber sheet material 21 move to the pressing area 33, such that the first roller 31 and the second roller 32 press the plastic substrate 11 and the fiber sheet material 21 in parallel into a composite film 34. Therein, because the first roller 31 and the second roller 32 have a relatively low temperature, when the plastic substrate 11 and the fiber sheet material 21 having a higher temperature and presented in a molten status are pressed with each other into the composite film 34, the first roller 31 and the second roller 32 efficiently lower the temperature of the composite film 34, such that the plastic substrate 11 and the fiber sheet material 21 are stably combined, thereby improving the structural strength of the composite film 34. Further, in another embodiment of the present invention, the plastic substrate 11 is not limited to be disposed on one side of the fiber sheet material 21; in other words, the plastic substrate 11 is allowed to be disposed on two sides of the fiber sheet material 21, such that the fiber sheet material 21 is sandwiched between the plastic substrates 11, thereby further enhancing the strength of the composite film 34.

As shown by FIG. 2 and FIG. 3, in the embodiment, the pressing module 30 comprises a guiding wheel 35, an adjustment unit 36, and a third roller 37. The guiding wheel 35 is disposed in adjacent to the second roller 32, so as to force the fiber sheet material 21 to abut against the outer periphery of the second roller 32, whereby the fiber sheet material 21 is able to flatly and smoothly enter the pressing area 33 (preventing the fiber sheet material 21 from having crease) to be pressed in parallel together with the plastic substrate 11. The adjustment unit 36 is connected with the first roller 31, the second roller 32, and the third roller 37, wherein the adjustment unit 36 is able to adjust the width of the pressing area 33 according to the users' demands, thereby adjusting the thickness of the composite film 34. The third roller 37 is disposed on one side of the second roller 32 away from the first roller 31, with a second pressing area 38 formed between the third roller 37 and the second roller 32. The third roller 37 further lowers the temperature of the composite film 34, preventing the composite film 34 from being insufficiently cured because the temperature has not dropped to a suitable range, which might affect the yield of the subsequent process. The composite film 34 enters the second pressing area 38 from the pressing area 33 along the second roller 32, so as to be delivered to the trimming module 40, the cleaning module 50, the stretching module 60, and the rolling module 70 for corresponding manufacturing processes.

Therein, as shown by FIG. 2 and FIG. 3, in the embodiment, the adjustment unit 36 is a combination of a screw and a thread bore, so that the first roller 31, the second roller 32, and the third roller 37 are able to be adjusted higher or lower according to actual demands. In another embodiment, the adjustment unit 36 is also allowed to be a gear set. Also, the form of the adjustment unit 36 is not limited in the present invention, as long as the adjustment unit 36 is able to adjust the width of the pressing area 33 in a displacement manner. The trimming module 40 is configured to trim the edge of the composite film 34, whereby the edge of the composite film 34 is smoothed. The cleaning module 50 is configured to clean the surface of the composite film 34, preventing any residue of dust, powder, or trimmed material on the surface of the composite film 34. The stretching module 60 is disposed before the rolling module 70, so as to further increase the resistance of the composite film 34 being pulled by the rolling module 70, whereby the composite film 34 is maintained in a highly tense and stretched status before entering the rolling module 70. The rolling module 70 is configured to roll up the composite film 34. With the stretching module 60 stretching the composite film 34, the composite film 34 is maintained in the highly tense and stretched status, so that the composite film 34 is tightly rolled up into a roll shape.

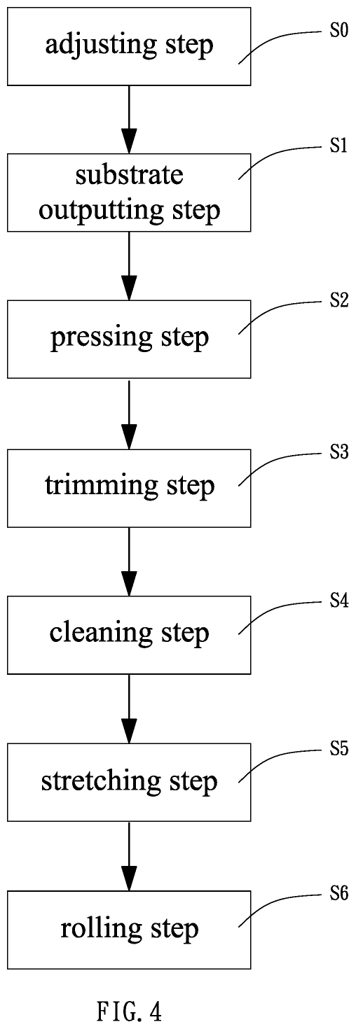

The present invention provides a thermoplastic fiber composite film manufacturing method, as shown by FIG. 4, in view of FIG. 2 and FIG. 3. The thermoplastic fiber composite film manufacturing method comprises an adjusting step S0, a substrate outputting step S1, a pressing step S2, a trimming step S3, a cleaning step S4, a stretching step S5, and a rolling step S6.

In the adjusting step S0, according to actual demands, the user is allowed to adjust the width of the pressing area 33 of the pressing module 30 through the adjustment unit 36 of the pressing module 30, so as to adjust the thickness of the composite film 34. Therein, the user is also allowed to adjust the width of the second pressing area 38 of the pressing module 30 through the adjustment unit 36. The form of the adjustment unit 36 is not limited in the present invention, as long as the adjustment unit 36 is able to adjust the width of the pressing area 33 in a displacement manner.

In the substrate outputting step S1, the substrate outputting module 10 outputs the plastic substrate 11 formed in a film shape and in a molten status along the output direction X. Therein, the plastic substrate 11 is formed of the plastic raw material which is heated and melted through the heating part 13 of the substrate outputting module 10. The plastic raw material is allowed to be a thermoplastic raw material, such as PVC or Nylon material.

In the pressing step S2, the pressing module 30 receives the plastic substrate 11 and the fiber sheet material 21 of the fiber material outputting module 20; then, the first roller 31 and the second roller 32 of the pressing module 30 press the plastic substrate 11 and the fiber sheet material 21 in parallel into the composite film 34. Therein, the composite film 34 goes through pressing area 33 between the first roller 31 and the second roller 32, whereby the first roller 31 and the second roller 32 press the plastic substrate 11 and the fiber sheet material 21 in parallel into the composite film 34.

In the trimming step S3, the trimming module 40 receives the composite film 34 and trims the edge of the composite film 34, whereby the edge of the composite film 34 is formed in a smooth shape. Therein, the flat and smooth composite film 34 is easier to be rolled up, and the aesthetic appearance of the composite film 34 is improved.

In the cleaning step S4, the cleaning module 50 receives the composite film 34 and carries out the cleaning process on the surface of the composite film 34, thereby cleaning the dust and powder residue on the surface of the composite film 34, facilitating the subsequent rolling process of the composite film 34.

In the stretching step S5, the stretching module 60 receives the composite film 34 to further increase the stretching resistance of the composite film 34, thereby carrying out the stretching and expanding process, so that the composite film 34 is in a stretched and expanded status, facilitating the subsequent rolling process of the composite film 34.

In the rolling step S6, the rolling module 70 receives the composite film 34 and rolls up the composite film 34 into a roll shape. Therein, through the process of the trimming step S3, the cleaning step S4, and the stretching step S5, the composite film 34 is rolled up much tightly and solidly by the rolling step S6, so as to reduce the overall volume and the storage space requirement of the composite film 34, thereby lowering the storage and transportation cost.

With the foregoing configuration, the present invention achieves following advantages.

The outputting part 14 of the substrate outputting module 10 of the present invention is formed in a flat shape, so that the outputting part 14 outputs the plastic substrate 11 in a sheet shape and unifies the thickness of the plastic substrate 11, preventing the inconsistent thickness of the plastic substrate 11.

The guiding wheel 35 of the pressing module 30 of the present invention forces the fiber sheet material 21 to adhere to the outer periphery of the second roller 32 and enter the pressing area 33, preventing the fiber sheet material 21 from having crease before entering the pressing area 33, whereby the fiber sheet material 21 and the plastic substrate 11 are tightly pressed in parallel to form the composite film 34.

The width of the pressing area 33 of the present invention is fixed, so as to fix the thickness of the composite film 34, thereby achieving the unified thickness of the composite film 34. Also, the first roller 31 and the second roller 32 of the present invention have a relatively low temperature, so as to efficiently lower the temperature of the composite film 34, whereby the plastic substrate 11 and the fiber sheet material 21 are stably combined, improving the structural strength of the composite film 34.

The pressing module 30 of the present invention comprises the third roller 37 and the second pressing area 38, so as to further lower the temperature of and press the composite film 34, thereby further improving the structural strength of the composite film 34.

The composite film 34 of the present invention is manufactured through a one-step process, achieving the advantages of higher manufacturing speed, lower production cost, and easy to produce in large quantities. Also, the composite film 34 manufactured by the present invention has higher flexibility.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A thermoplastic fiber composite film manufacturing mechanism, comprising:
a substrate outputting module configured to continuously output a plastic substrate formed in a film shape and in a molten status along an output direction;
a fiber material outputting module disposed on one side of the substrate outputting module, the fiber material outputting module having a rolled-up fiber sheet material, the fiber material outputting module configured to continuously output the fiber sheet material; and
a pressing module disposed on one side of the fiber material outputting module away from the substrate outputting module, the pressing module comprising a first roller and a second roller neighboring each other, with a pressing area formed between the first roller and the second roller, the pressing module receiving the plastic substrate and the fiber sheet material, the plastic substrate and the fiber sheet material moving to the pressing area, such that the first roller and the second roller press the plastic substrate and the fiber sheet material together in parallel to form a composite film.

2. The thermoplastic fiber composite film manufacturing mechanism of claim 1, wherein the substrate outputting module comprises an inputting part, a heating part, and an outputting part orderly disposed along the output direction; the inputting part is configured to input a plastic raw material, and the heating part is configured to heat the plastic raw material to form the plastic substrate which is then outputted through the outputting part.

3. The thermoplastic fiber composite film manufacturing mechanism of claim 2, wherein the outputting part is formed in a flat shape and expands toward the output direction.

4. The thermoplastic fiber composite film manufacturing mechanism of claim 1, wherein the fiber material outputting module comprises a resistance mechanism passing through the fiber sheet material along an axial direction of the fiber sheet material.

5. The thermoplastic fiber composite film manufacturing mechanism of claim 1, wherein the pressing module comprises a guiding wheel disposed neighboring the second roller; the guiding wheel is configured to force the fiber sheet material to adhere to an outer periphery of the second roller.

6. The thermoplastic fiber composite film manufacturing mechanism of claim 1, wherein the pressing module comprises an adjustment unit connected with the first roller and the second roller for adjusting a width of the pressing area.

7. The thermoplastic fiber composite film manufacturing mechanism of claim 1, wherein the pressing module comprises a third roller disposed on one side of the second roller away from the first roller, with a second pressing area formed between the third roller and the second roller; the composite film enters the second pressing area along an outer periphery of the second roller.

8. The thermoplastic fiber composite film manufacturing mechanism of claim 1, further comprising a trimming module, a cleaning module, a stretching module, and a rolling module, wherein the trimming module, the cleaning module, the stretching module, and the rolling module are orderly disposed toward a direction of the pressing module away from the substrate outputting module.

9. A thermoplastic fiber composite film manufacturing method, comprising:
a substrate outputting step, using a substrate outputting module to output a plastic substrate formed in a film shape and in a molten status along an output direction; and
a pressing step, receiving the plastic substrate and a fiber sheet material outputted by a fiber material outputting module through a pressing module, and using the pressing module to press the plastic substrate and the fiber sheet material together in parallel to form a composite film.

10. The thermoplastic fiber composite film manufacturing method of claim 9, wherein in the substrate outputting step, the plastic substrate is formed of a plastic raw material heated and melted by a heating part of the substrate outputting module.

11. The thermoplastic fiber composite film manufacturing method of claim 9, wherein before the substrate outputting step, an adjusting step is comprised, in which a width of a pressing area of the pressing module is adjusted through an adjustment unit of the pressing module, thereby adjusting a thickness of the composite film.

12. The thermoplastic fiber composite film manufacturing method of claim 11, wherein after the pressing step, a trimming step is further comprised, in which a trimming module receives the composite film and trims the composite film, so that an edge of the composite film is formed in a smooth shape.

13. The thermoplastic fiber composite film manufacturing method of claim 12, wherein after the trimming step, a cleaning step is further comprised, in which a cleaning module receives the composite film and carries out a cleaning operation on a surface of the composite film.

14. The thermoplastic fiber composite film manufacturing method of claim 13, wherein after the cleaning step, a stretching step is further comprised, in which a stretching module receives the composite film and carries out a stretching operation on the composite film, so that the composite film is in a tense status.

15. The thermoplastic fiber composite film manufacturing method of claim 14, wherein after the stretching step, a rolling step is further comprised, in which a rolling module receives the composite film and rolls up the composite film.
